(19) United States
(12) Patent Application Publication
(10) Pub. No.: US 2022/0046947 A1
(43) Pub. Date: Feb. 17, 2022

(54) HYDROLYSED PHOSPHOLIPID COMPOSITION AND METHOD OF MAKING THE SAME

(71) Applicant: ECOVATEC SOLUTIONS INC., Abbotsford (CA)

(72) Inventors: William PERRIN, White Rock (CA); Christopher NICHOLS, Coquitlam (CA); Harry TEN HAAF, Langley (CA); Glenn NICHOLS, Maple Ridge (CA)

(73) Assignee: ECOVATEC SOLUTIONS INC., Abbotsford, BC (CA)

(21) Appl. No.: 17/279,056

(22) PCT Filed: Sep. 19, 2019
(86) PCT No.: PCT/CA2019/051335

§ 371 Date: Mar. 23, 2021

(30) Foreign Application Priority Data
Sep. 24, 2018 (CA) 3018403

(51) Int. Cl. A23J 1/08; A23J 3/34; A23J 7/00

(52) U.S. Cl. CPC A23J 1/08; C12Y 304/21004; A23J 7/00; A23J 3/341

(57) ABSTRACT

There is a method of producing a hydrolysed egg yolk plasma product from egg yolk elements. The egg yolk elements include phospholipids and proteins. The method comprises introducing a hydrolysing agent into the egg yolk elements to hydrolyse at least a portion of the proteins in the egg yolk elements to form the hydrolysed egg yolk plasma product. There also is a composition formed using the method above. There is also an egg yolk composition formed from egg yolk, comprising at least 15% phospholipids solids by dry mass, at least 20% protein by dry mass, the protein being at least partially hydrolysed into peptides and at least 40% lipids other than phospholipids by dry mass.

### TECHNICAL FIELD

This relates to hydrolysed phospholipid compositions and methods of making those composition. In particular, this relates to hydrolysed egg yolk plasmas.

### BACKGROUND

Two papers have investigated the effect of using phospholipase (PLA1, PLA2) on the emulsification characteristics of egg yolk plasma:

1) Jin, Yong-Guo, Dan Huang, Tian Ding, Mei-Hu Ma, and Deog-Hwan Oh. “Effect Of Phospholipase AlOn The Physicochemical And Functional Properties Of Hens Egg Yolk, Plasma And Granules.” Journal of Food Biochemistry 37, no. 1 (2011): 70-79. doi:10.1111/j.1745-4514.2011.00608.x; and

2) Strixner, Thomas, Rebecca Würth, and Ulrich Kulozik. “Combined Effects of Enzymatic Treatment and Spray Drying on the Functional Properties of Egg Yolk Main Fractions Granules and Plasma.” Drying Technology 31, no. 13-14 (2013): 1485-496. doi:10.1080/07373937.2013.790411.

The first paper examined the results of using of PLA1 and noted the increase in foaming properties and heat stability. The second paper investigated PLA2 and specifically noted that PLA2 cleaves a fatty acid off of phospholipids, creating a lyso-phospholipid and a free fatty acid. This is also known as lysophosphatidic acid (LPA). The creation of lysophospholipids allows for greater water solubility and temperature stability. They therefore used PLA2 prior to spray-drying the plasma. The heat stability is due to a complex that is formed between the lyso-phospholipids and LDL apoproteins.

However, this LPA (lysophosphatidic acid) has been shown to have negative effects on many bodily systems. Scientific literature has shown links between LPA signaling in the body and colon, ovarian, and liver cancer. It has also been linked to brain changes, including schizophrenia, Alzheimer's, and traumatic brain injury. One specific paper links dietary LPA to colon tumorigenesis in rats: Tsutsumi, Toshihiko, Manami Inoue, Yoko Okamoto, Akira Ishihara, and Akira Tokumura. “Daily Intake of High-Fat Diet with Lysophosphatidic Acid-Rich Soybean Phospholipids Augments Colon Tumorigenesis in Kyoto Apc Delta Rats.” Digestive Diseases and Sciences 62, no. 3 (2017): 669-77. doi:10.1007/s10620-016-4434-5.

In general, although lipid hydrolysis may improve heat stability and viscosity, it creates LPA and a distinct negative off taste.

Other methods of selectively isolating phospholipids (PL) from the remaining lipids and proteins use additional separation techniques typically using other harsh solvents.

### SUMMARY

In an embodiment there is disclosed a method of producing a hydrolysed egg yolk plasma product from egg yolk elements. The egg yolk elements include phospholipids and proteins. The method comprises introducing a hydrolysing agent into the egg yolk elements to hydrolyse at least a portion of the proteins in the egg yolk elements to form the hydrolysed egg yolk plasma product.

In another embodiment there is a composition formed using the method above.

In another embodiment there is an egg yolk composition formed from egg yolk, comprising at least 15% phospholipids solids by dry mass, at least 20% protein by dry mass, the protein being at least partially hydrolysed into peptides and at least 40% lipids other than phospholipids by dry mass.

The foregoing summary is not intended to summarize each potential embodiment or every aspect of the subject matter of the present disclosure.

These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a plan diagram of a method of forming a dried hydrolysed egg yolk composition.

FIG. 2 is a chart representing the viscosities of each of various phospholipid compositions.

FIG. 3 is a chart representing the percentage of oil separation for each of the compositions.

FIG. 4 is a chart representing the percentage of acetones insoluble in each of the compositions.

FIG. 5 is a chart representing the relative fluorescence of lysophosphatidic acid (LPA) for each of the compositions.

FIG. 6 is a plan diagram of a method of forming a hydrolysed egg yolk plasma.

### DETAILED DESCRIPTION

Immaterial modifications may be made to the embodiments described here without departing from what is covered by the claims.

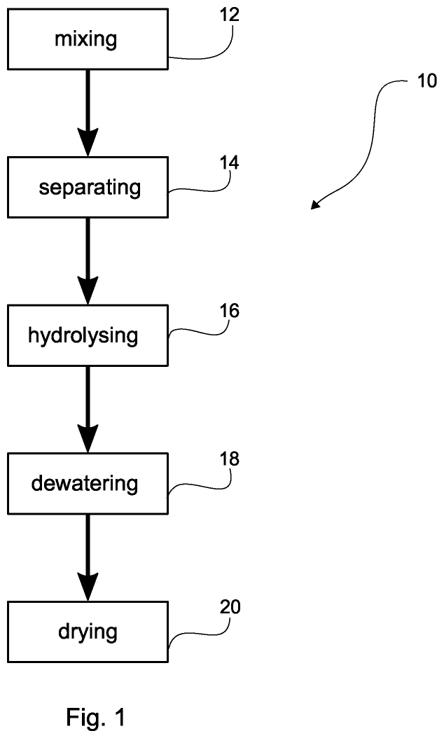

FIG. 1 shows one embodiment of a method 10 of obtaining a dried egg yolk composition. At 12, water and, optionally, salt are mixed with a liquid egg yolk to form a mixed product. At 14, the mixed product is separated from the granules to form a plasma, the plasma comprising proteins and phospholipids. At 16, at least a portion of the proteins within the plasma are hydrolysed to form a hydrolysed plasma. At 18, the hydrolyzed plasma is dewatered to remove at least a portion of the water and salt and water-soluble proteins. At 20, the dewatered plasma is dried to form a dry powder.

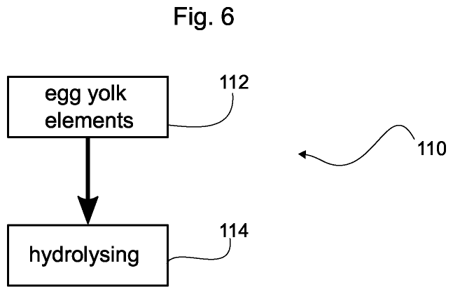

In another embodiment as shown in FIG. 6 there is a method 110 of producing a hydrolysed egg yolk plasma product from egg yolk elements 112. The egg yolk elements 112 include phospholipids and proteins. The method comprises introducing a hydrolysing agent into the egg yolk elements at 114 to hydrolyse at least a portion of the proteins in the egg yolk elements to form the hydrolysed egg yolk plasma product.

Herein, the egg yolk elements comprise a combination of avian egg yolk phospholipids and proteins. The egg yolk elements may be an egg yolk plasma, dried egg yolk unmodified egg yolk or other forms of egg yolks containing egg yolk phospholipids and proteins. Preferably, the egg yolk elements are egg yolk elements from chicken eggs. The chicken may be a hen of any domesticated breed of chicken, since the egg yolks of hens of all domesticated breeds of chicken contain substantially similar phospholipids and proteins. Other avian eggs may also be used since they have a similar composition of plasma. The type of bird, diet and other factors may affect yolk quality and constituent parts as does egg yolk age. However, other avian egg yolks other than chicken may be of limited industrial applicability since other avian eggs are generally considerably more expensive than chicken eggs.

Hydrolysing the proteins at 114 may be done by hydrolysing the proteins using a proteolytic enzyme. Hydrolysing the proteins can be done using a combination of enzymes including the proteolytic enzyme. The proteolytic enzyme may be one or more of the following: trypsin, chymotrypsin, pepsin, bromelain, papain, fungal proteases, and serratia peptidase. Preferably, the proteolytic enzyme is mainly or exclusively trypsin.

An egg yolk plasma may be produced prior to hydrolysing at least a portion of the proteins in the egg yolk elements. The egg yolk plasma may be produced by mixing water with egg yolk elements to form a mixed product and separating the mixed product by removing yolk granules from the mixed product to form the egg yolk plasma, for example as shown in 12 and 14 of FIG. 1. Mixing water with egg yolk elements to form a mixed product may optionally, and preferably, be done with the addition of salt while mixing the water and the egg yolk elements.

The egg yolk elements may be a mixed egg yolk product and the proteolytic enzyme may be introduced into the mixed egg yolk product to form a hydrolysed mixed product followed by removing egg yolk granules from the hydrolysed mixed product to form the egg yolk plasma product.

The hydrolysed egg yolk plasma may also be dewatered as shown in 18 of FIG. 1 to remove at least a portion of the water and salt and water-soluble proteins. Dewatering the hydrolysed egg yolk plasma product may be done by filtering the hydrolysed egg yolk plasma product, although other methods may be used. The dewatered hydrolysed egg yolk plasma product may also be dried to form a dry powder. Drying the dewatered plasma as shown in 20 of FIG. 1 may be done by any number of methods, including spray drying the dewatered plasma.

Using these methods, it is possible to hydrolyse at least a portion of the proteins in the egg yolk elements or, optionally, to fully hydrolyse the proteins in the egg yolk elements. The composition created by this method may result in a product with at least 15% phospholipids solids by dry mass. In particular, the composition may have 15% to 30% phospholipids solids by dry mass.

It is possible to employ this method using egg yolk elements that are initially in the form of dried egg yolk. The mixing of the water and salt with the egg yolk elements may be done using a cavitation device, although other mixing techniques may be used. Separating the mixed product may be done by passing the mixed product through a centrifuge, although other separation techniques may be used.

By using the methods disclosed herein, an egg yolk composition may be formed from egg yolk.

In some embodiments, the egg yolk composition may have the following properties:

at least 15% phospholipids solids by dry mass;

at least 20% protein by dry mass, the protein being at least partially hydrolysed into peptides; and

at least 40% lipids other than phospholipids by dry mass.

Preferably, the egg yolk composition may have 15-30% phospholipids solids by dry mass. The egg yolk composition preferably comprises no more than minimal amounts of lysophosphatidic acid. The egg yolk composition may be made into a dried powder having less than 5% moisture content.

The egg yolk composition may be hydrolysed so that the protein in the composition is fully hydrolysed into peptides.

The egg yolk composition having between 15-30% phospholipids solids by dry mass is described herein as “PL-20H”. The hydrolyzation process modifies the associated lipid/protein structures and may result in increased solubility and miscibility in water. In some embodiments the composition may provide better emulsification properties than similar non-hydrolysed products. PL-20H may in some embodiments provide clean, high-quality egg yolk products efficiently and at lower costs than standard methods. A composition as provided herein may be formed from natural egg proteins and lipids that are not contaminated and denatured by harsh solvents.

Embodiments of PL-20H may have a broad range of useful applications. PL-20H may be used as a food ingredient to not only boost nutritional value but to serve as an emulsifier and binder. It may be used in many baked goods, ice cream, and chocolate. PL-20H may also have applications for nutraceuticals, dietary supplements, as well as cosmetic products. When in a dry powder form, it is easy to use and store.

As discussed above, one example application of certain embodiments of PL-20H is as a nutraceutical. Lutein and zeaxanthin are some of the natural carotenoids found in yolk. The low temperature, non-solvent processing of PL-20H minimizes degradation of the lutein and zeaxanthin in the yolk and concentrates it versus whole yolk products. Lutein and zeaxanthin have been shown to be better absorbed from egg yolks likely due to being combined with egg yolk triglycerides encapsulated with phospholipids. These carotenoids, when taken orally, have shown in studies to have numerous beneficial effects for skin and eye health.

Another example application of certain embodiments of PL-20H is for cosmetics. Triglycerides, cholesterol and carotenoids such as lutein and zeaxanthin from egg yolk have value in the cosmetic industry for use on dry skin and to treat conditions such as eczema. This product is a concentrate of these components from the yolk, naturally encapsulated within phospholipids which if incorporated into cosmetics can be used in water or oil-based formulations to deliver these triglycerides, cholesterol and carotenoids to the skin.

Another application of certain embodiments of PL-20H is as an emulsifier. Due to its high efficiency and natural origin and biodegradability, PL-20H has application for emulsifying oils in industrial processes such as wastewater treatment and incorporation of oil based products in industries such as pulp and paper, plastics and coatings.

In some embodiments, a specific PL-20H product may have the following attributes:

1. Appearance: Pale-Yellow Powder

2. Phospholipids 20%

3. Phosphatidylcholine 16.8%

4. Phosphatidylethanolamine 2.45%

5. Others 0.75%

A sample of an exemplary composition of PL-20H was tested for certain properties in Table 1 below. The first column ‘test items’ represents the item that was tested. The next column ‘specifications’ represents the desired characteristics for the sample. The next column ‘analytical values’ represents the result of the test. The final column ‘method’ represents the type of testing method used.

TABLE 1

| Test Items | Specifications | Analytical Values | Method |
|---|---|---|---|
| Appearance/Color | Light orange- | Passed | Visual |
| | yellow | | |
| Appearance/Form | Fine Powder | Passed | Visual |
| Total PL | >20% | 20.10% | ICPMS |
| Moisture | <5% | 1.60% | AOAC 935.29 |
| Ash | NMT 10% | 4.80% | AOAC 942.05 |
| Heavy Metals* - | NMT 10 ppm | NMT 0.2 ppm | ICPMS |
| As, Pb, Hg, Cd | | | |
| Aerobic Plate | NMT 5,000 cfu/g | NTM 20 cfu/g | MFHPB-18 |
| Counts | | | |
| Coliform | Not Detected | Not Detected | MFHPB-34 |
| Salmonella | Negative | Negative | MFHPB-20 |
| E. coli | Not Detected | Not Detected | MFHPB-34 |

Further testing was conducted on some exemplary samples of PL-20H, to evaluate the rheological, physicochemical and microstructural properties of non-enzymatically modified (PL20) or enzymatically-modified (PL20H) lysophosphatidic acid-free egg yolk containing higher ratio of phospholipids to proteins. PL20, PL20H, GRAN (egg yolk granules), PL30J and PL 30C (solvent extracted, 30% phospholipid egg yolk products from two different processors), Commercially Available Enzyme Modified egg yolk Powder (CEYP) and Soy Phospholipid Powder (SPP) were compared.

Emulsions were prepared with 79.0% vegetable oil, 10.1% water, 7.3% white vinegar, 1.8% emulsifier, and 1.3% salt using a food processor and tested for heat stability using convective and radiation heat transfer. Viscosity, color, acetone insoluble, acid value, peroxide value, LPA, droplet sizes, and stability were analyzed.

### Results

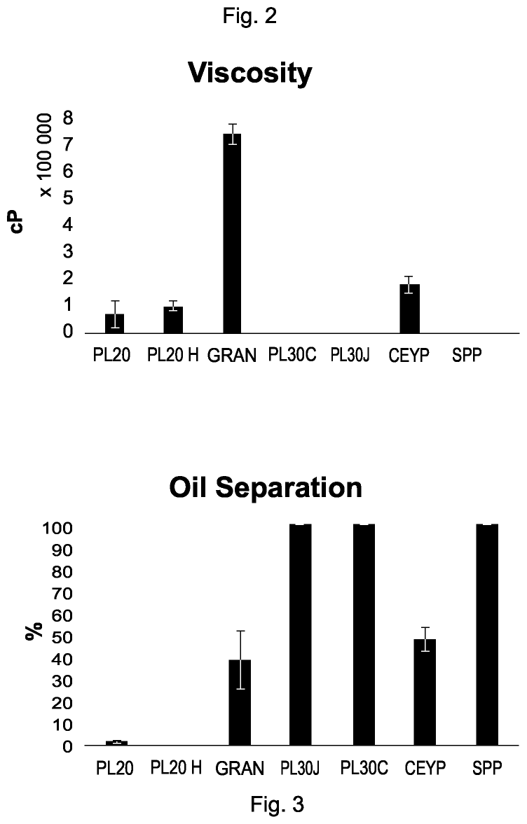

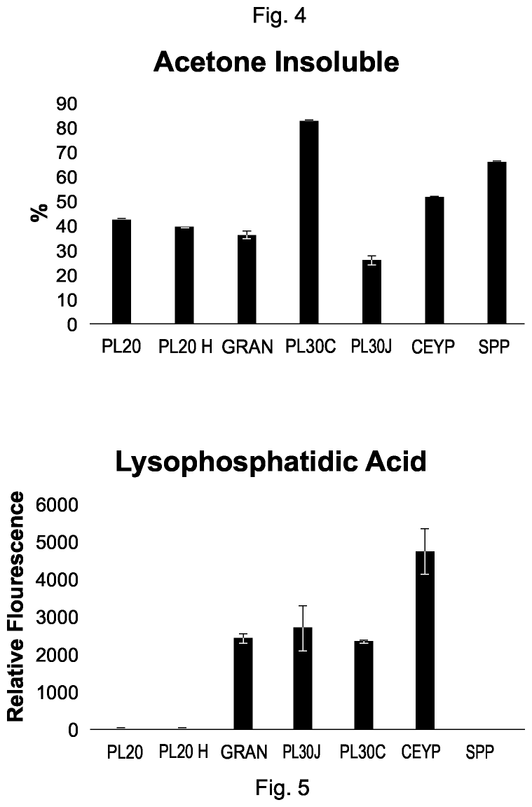

Viscosity, color, acetone insoluble, acid value, peroxide value, droplet sizes, and stability were analyzed. FIG. 2 represents the viscosities of each of the various compositions. FIG. 3 represents percentage of oil separation for each of the compositions. FIG. 4 represents the percentage of acetones insoluble in each of the compositions. FIG. 5 represents the relative fluorescence of lysophosphatidic acid (LPA) for each of the compositions. PL20H and PL20 showed 0% and 1% oil separation, respectively followed by GRAN (39%±2) and CEYP (48%±5). PL30C, PL30J and SPP showed more than 50% oil separation. PL20H>PL20>GRAN>CEYP withstood 10 s of microwave heating while PL30J, PL30C and SPP collapsed. GRAN viscosity (722,667±37,717 cP)>CEYP (172,750±31,556 cP)>PL20H (96,683±1,553 cP)>PL20 (68,800±4,752 cP). PL20, PL20H, and CEYP had the lightest color (4±0.0) followed by PL30C (5±0.1), SPP (6±0.0), GRAN (12±0.2) and PL30J (17±0.8). PL30C had the highest percentage of acetone insolubles (82%±0.3) followed by SPP (65%±0.22), CEYP (50%±0.03), PL20 (42%±0.30), PL20H (39%±0.10), and GRAN (35%±1.64) and PL30J (25%±1.67). Acid values were <36 for all samples. Peroxide values showed minimal oxidation in all samples (<0.1030 mEq/kg). CEYP had the smallest droplet sizes followed by PL20H, PL20, and LPA was not detected in PL20, PL20 H and SPP. PL20H had better rheological and physicochemical properties than PL20, GRAN, CEYP, PL30C, PL 30J or SPP.

The results are also summarized in table 2, below:

TABLE 2

| | Colour | | | | Heat | Peroxide |
|---|---|---|---|---|---|---|
| | | | | Gardner | Stability | value |
| Sample | L | a* | b* | Scale | 10 seconds | mEq/kg |
| PL20 | 91.1 ± | 2.34 ± | 25.2 ± | 4 | ✓ | .1022 ± 0.002 |
| | 0.01 | 0.05 | 0.02 | | | |
| PL20 H | 91.6 ± | 3.33 ± | 29.5 ± | 4 | ✓ | .1021 ± 0.002 |
| | 0.01 | 0.02 | 0.05 | | | |
| GRAN | 75.6 ± | 0.92 ± | 51.5 ± | 12 | ✓ | .1021 ± 0.000 |
| | 0.03 | 0.05 | 0.25 | | | |
| PL30-C | 89.6 ± | 4.43 ± | 28.4 ± | 5 | x | .1022 ± 0.003 |
| | 0.00 | 0.02 | 0.10 | | | |
| PL30-J | 53.5 ± | 19.8 ± | 63.8 ± | 17 | x | .1024 ± 0.003 |
| | 0.92 | 0.09 | 0.85 | | | |
| CEYP | 90.5 ± | 1.88 ± | 23.7 ± | 4 | ✓ | .1023 ± 0.003 |
| | 0.05 | 0.02 | 0.02 | | | |
| SPP | 83.8 ± | 4.02 ± | 32.0 ± | 6 | x | .1023 ± 0.004 |
| | 0.01 | 0.01 | 0.05 | | | |

One exemplary method of producing a hydrolysed egg yolk plasma product from egg yolk elements is described as follows.

### Exemplary Method

Fresh liquid egg yolk is mixed with water at a ratio of 1:4. Salt is added to mixture at a rate of 0.5% of total volume. The solution is mixed through a cavitation device for a period of approximately 20 minutes (cycling the total volume twice through the cavitation device). Cavitation is achieved through a high-pressure pump and cavitation device. Cavitation may allow for proper separation of plasma from granule during centrifuging with less mixing and/or dwell time needed prior to centrifuging versus non-cavitated egg yolk, water and salt mixtures. Although cavitation is preferred, any high shear mixing will likely have a similar effect.

The mixed solution is then transferred and undergoes centrifugation above 10000 G force to separate out plasma from granule. Various types of solid/liquid type separator or centrifuge equipment may be used as long as the process removes solids, wherein the plasma is the liquid portion and the granule is the solids. Separation of the plasma may be done through processes other than centrifugation. The plasma is then adjusted for pH and temperature to the optimal setpoint for trypsin hydrolysis and trypsin is added at a rate of 1:50 weight of enzyme to expected dry weight of protein in the plasma. Through experimentation protein content in the plasma this is known to be roughly 25% of the solids. Preferably the pH is adjusted initially to approximately 7.0. Generally, the pH does not need to be adjusted after the hydrolysis begins. Minor changes in pH following the initial adjustment have not been shown to result in major changes in the end product.

Preferably, temperature is maintained at the optimal level during hydrolysis for a period of 16 hours. For example, preferably, the temperature is maintained at 38-40 C throughout. However, variations in temperature, such as temperatures drops due to heat loss from the plasma being left in tanks overnight, which may result in temperature losses of approximately 4-6 C by the end of the period, have not shown identifiably different results. The length of time may vary depending upon degree of hydrolysis desired and the length of time could be longer or shorter as set out in Table 3 below. Also, different enzymes and different starting amounts can result in the same end product with shorter or longer hydrolysis times.

Preferably, the solution is dewatered and desalted using a 500 kDa ultrafiltration cross flow membrane filter until the solids content in the retentate is roughly 18-20%. In other embodiments, different dewatering techniques may be used.

The retentate is then spray dried to a powder with moisture content of below 5%. Various different nozzle or atomizer designs may be used to spray dry the powder as well as different specific locations in the spray dryers in which the product is atomized depending upon the design and type. Other drying techniques may also be used.

Possible exemplary ranges for producing a hydrolysed egg yolk plasma product are set out in Table 3 below:

TABLE 3

| | | Preferred ranges | |
|---|---|---|---|
| Steps | Possible ranges | and/or values | |
| Water to egg yolk ratio | between 20:1 and 1:1 | 4:1 | |
| Salt addition | between 0% and 2% | 0.50% | |
| (of total volume) | | | |
| Cavitation duration | between 0 and 120 | 20 | |
| (minutes) | | | |
| Centrifugation G-force | greater than 2000 g | greater than 10,000 g | |
| Hydrolysis method | any method | proteolytic enzyme | |
| Enzyme used | any proteolytic enzyme | trypsin | |
| Amount of trypsin to dry | between 1:10 and 1:500 | 1:50 | |
| protein mass | | | |
| pH of trypsin hydrolysis | 6-10 | 7.0 | |
| Temperature of hydrolysis | 10 C. to 60 C. | 38 C. to 40 C. | |
| Time of hydrolysis | 2 hours to 48 hours | 15 | hours |
| Filtration after hydrolysis | optional | 500 | kDa |

| | | |
|---|---|---|
| (MWCO) | | |
| Post filtration solids | 1-40% | 18-20% |
| content | | |
| Final water content | <10% | <5% |

The process may be done using any proteolytic enzyme and any degree of hydrolysis of the protein such as a partially hydrolysed protein through to fully hydrolysed protein.

In some embodiments, PL-20H is a commercial product obtained through the processing of liquid egg yolk. The plasma portion of the egg yolk solution after separation via centrifuge or other techniques from the granules (or HDL or non-dissolved solids) portion of the egg yolk is hydrolysed or partially hydrolysed using any protease or combination of proteases to affect the protein fraction of the plasma prior to molecule weight selective filtration of the solution to remove any free small protein peptide fragments as well as water, other processing ingredients as well as any soluble small molecular weight proteins from the plasma. Alternatively, plasma may undergo filtration and dewatering prior to hydrolysis or partial hydrolysis of the proteins.

In any case, the product may be dried (spray dryer, freeze dry, any other drying methodology) with or without milling in order to create a stable powdered product.

Some embodiments of PL-20H are different from most other known emulsifiers previously produced because:
1. It is isolated fraction (plasma) of the egg yolk most responsible for emulsion capability of egg yolks;
2. It is produced such that proteins are retained to improve functionality as an emulsifier;
3. The proteins are hydrolysed to significantly improve miscibility of the product in water;
4. The hydrolysed protein peptides also work to improve other emulsion properties such as heat stability and viscosity;
5. It is tested to have only minimally present naturally occurring LPA, an suspected carcinogen; and
6. The product has a lower color and off flavor characteristics versus other egg and soy based emulsifiers.

In some embodiments, the composition PL-20H has been analysed in comparison to various other common emulsifiers, both egg-based and other. The effect of proteolytic hydrolysis results in a powder that is more easily miscible in water and does not separate in water versus non-protein hydrolysed egg phospholipid emulsifiers.

Typical enzymatic modification of egg yolk to improve heat stability and viscosity versus a non-hydrolysed egg yolk is performed with various lipase enzymes acting on the lipid portion of the yolk and results in lysophosphatidic acid formation (LPA). LPA has been recently linked to numerous cancers through a variety of mechanisms. Embodiments of PL-20H may have no LPA, because it does not enzymatically hydrolyse the lipids in its production. Enzymatic modification using lipases also results in a characteristic undesired off taste making it poorly suited to many products.

Embodiments of PL-20H show dramatically improved heat resistance and emulsion viscosity when compared against several other non-hydrolysed egg and soy based emulsifiers tested.

Besides its function as an emulsifier, PL-20H may be utilized in a variety of food and nutraceutical products as a source of:
1. phospholipids including phosphatidylcholine as a source of choline;
2. a source of lipids,
3. a source of egg yolk peptides:
4. a source of cholesterol;
   and functionally, PL-20H may be used for liposomal encapsulation of other immiscible ingredients for incorporation into end products including pharmaceutical applications, nutritional supplements or functional beverages.

PL-20H may also be used as an effective emulsifier and source of peptides for cosmetics.

Embodiments of PL-20H may have the following composition (the % denoting % mass by dry weight):
1. Phospholipids >20% (Phosphatidylcholine
2. Total Protein ˜25% (hydrolysed or partially hydrolysed into peptides)
3. Other lipids ˜45%
4. Ash 5%
5. Moisture 2%
6. Form: yellow/orange very fine powder

In some embodiments, the resulting composition is a naturally obtained extraction of phospholipids from fresh egg yolks. The extraction method requires no solvents and, other than the hydrolysing agent, only natural ingredients such as water and salt, much of which is removed again in the process.

The result is a pale yellow powdered product which can be stored in refrigerated storage for long periods of time or even at room temperature. The product has a very mild smell and taste so as not to impart any significant flavor impact to the product it is being added to. Being a powder, it is easy to incorporate into either the wet or dry ingredients within a recipe and is easy to measure and handle.

In some embodiments, the PL-20H product is an extremely efficient emulsifier and in laboratory testing was able to achieve much more effective oil incorporation, heat stability and emulsions with lower (better) viscosity than other commercial emulsifiers such as PL-30 paste, soy lecithin or enzyme modified egg yolk.

Because in some embodiments PL-20H is a very effective natural emulsifier, a lower amount can be used for the same effect as other emulsifiers. Being able to use a smaller amount of emulsifier results in an even lower flavor impact in the finished product compared to other egg yolk products.

Typical enzyme modified egg yolk which is used for a higher heat tolerant emulsifier is made using a phospholipase enzyme. During the enzyme hydrolysis of the phospholipids, this process creates high levels of Lysophosphatidic Acid. Lysophosphatidic Acid, or LPA, is a potent bioactive chemical used in the nervous system and has also been linked to inflammation and growth of various cancers. In addition to the documented health impacts of LPA, phospholipase modified egg yolk is also found to have a distinct negative off taste imparting unwanted flavor to the finished product it is used in. The PL-20H product is created by applying a proteolytic enzyme to affect the proteins, not the lipids, present in the product. The difference versus the typical enzyme modified egg yolk is that embodiments of the methods described herein do not increase the amounts of LPA found in the product.

Embodiments of the protein hydrolysed product PL-20H may quickly incorporate into any liquid with very little agitation and stays fully miscible in solution over large periods of time. Other products may require a slightly higher amount of mixing and can start to separate over time when mixed into pure water although in testing this does not negatively impact the resulting emulsion in the large majority of uses.

The hydrolysed product may also show a higher viscosity of emulsion than non-hydrolysed products.

Compared to other emulsifiers on the market embodiments of PL-20H may provide superior performance. The improved stability of the emulsion results in less breaking of products with heating or in very high ratio oil and water emulsions leading to a higher quality finished product.

Compared to many other commercial emulsifiers, embodiments of PL-20H product have a very mild taste and light color so as not to impart any negative attributes to the product it is being added to. In addition, the high effectiveness allows for a low quantity to be added further reducing any potential negative flavor impact in low flavored products.

Embodiments of PL-20H may be naturally high in the phospholipid phosphatidylcholine which is recognized as a healthy component of any diet and is often underrepresented in diets versus the suggested daily levels. Additionally, the PL-20H product does not contain the high levels of LPA that phospholipase modified egg yolk contains.

Being a high efficiency emulsifier, typically much lower amounts of embodiments of PL-20H emulsifier can be used with the same effect as the standard lowest cost emulsifiers. Also, easy storage, handling and measuring means less waste and less time when using this product versus some other commonly used emulsifiers.

Furthermore, in certain embodiments, the PL-20H composition can be produced with commercial yolks and using commercially available production equipment.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A method of producing a hydrolysed egg yolk plasma product from egg yolk elements, the egg yolk elements including phospholipids and proteins, the method comprising:
introducing a hydrolysing agent into the egg yolk elements to hydrolyse at least a portion of the proteins in the egg yolk elements to form the hydrolysed egg yolk plasma product.

2. The method of claim 1 in which hydrolysing the proteins further comprises hydrolysing the proteins using a proteolytic enzyme.

3. The method of claim 1 in which hydrolysing the proteins further comprises hydrolysing the proteins using a combination of enzymes including the proteolytic enzyme.

4. The method of claim 2 in which the proteolytic enzyme is one or more of the following: trypsin, chymotrypsin, pepsin, bromelain, papain, fungal proteases, and serratia peptidase.

5. The method of claim 4 in which the proteolytic enzyme is trypsin.

6. The method of claim 1 further comprising producing an egg yolk plasma prior to hydrolysing at least a portion of the proteins in the egg yolk elements, and in which producing the egg yolk plasma further comprises:
mixing water with egg yolk elements to form a mixed product; and
separating the mixed product by removing yolk granules from the mixed product to form the egg yolk plasma.

7. The method of claim 6 in which mixing water with egg yolk elements to form a mixed product further comprises mixing water and salt with the egg yolk elements to form the mixed product.

8. The method of claim 1 in which the egg yolk elements are a mixed egg yolk product and in which a proteolytic enzyme is introduced into the mixture to form a hydrolysed mixed product, followed by:
removing egg yolk granules from the hydrolysed mixed product to form the egg yolk plasma product.

9. The method of claim 7 further comprising dewatering the hydrolysed egg yolk plasma product to remove at least a portion of the water and salt and water-soluble proteins.

10. The method of claim 9 in which dewatering the hydrolysed egg yolk plasma product further comprises filtering the hydrolysed egg yolk plasma product.

11. The method of claim 10 further comprising drying the dewatered hydrolysed egg yolk plasma product to form a dry powder.

12. The method of claim 11 in which drying the dewatered plasma further comprises spray drying the dewatered plasma.

13. The method of claim 1 in which introducing a hydrolysing agent into the egg yolk elements to hydrolyse at least a portion of the proteins in the egg yolk elements further comprises fully hydrolysing the proteins in the egg yolk elements.

14. The method of claim 1 in which the composition created by the method comprises at least 15% phospholipids solids by dry mass.

15. The method of claim 14 in which the composition created by the method comprises between 15% to 30% phospholipids solids by dry mass.

16. The method of claim 1 in which the egg yolk elements further comprises dried egg yolk.

17. The method of claim 7 in which mixing water and salt with the egg yolk elements further comprises mixing water and salt with the egg yolk elements using a cavitation device.

18. The method of claim 7 in which separating the mixed product further comprises passing the mixed product through a centrifuge.

19. A composition formed using the method of claim 1.

20. An egg yolk composition formed from egg yolk, comprising:
at least 15% phospholipids solids by dry mass;
at least 20% protein by dry mass, the protein being at least partially hydrolysed into peptides; and
at least 40% lipids other than phospholipids by dry mass.

21. The egg yolk composition of claim 20 further comprising between 15-30% phospholipids solids by dry mass.

22. The egg yolk composition of claim 20 further comprising no more than minimal amounts of lysophosphatidic acid.

23. The egg yolk composition of claim 20 further comprising a dried powder having less than 5% moisture content.

24. The egg yolk composition of any claim 20 in which the protein is fully hydrolysed into peptides.
